(19) United States
(12) Patent Application Publication
(10) Pub. No.: US 2024/0037654 A1
(43) Pub. Date: Feb. 1, 2024

(54) CREDIT LOAN CONTROL METHOD AND SERVICE COMPUTING DEVICE THEREFOR

(71) Applicant: Sung Il KIM, Yongin-si (KR)

(72) Inventor: Sung Il KIM, Yongin-si (KR)

(21) Appl. No.: 18/351,746

(22) Filed: Jul. 13, 2023

(30) Foreign Application Priority Data
Jul. 28, 2022 (KR) 10-2022-0094126

(51) Int. Cl. G06Q 40/03

(52) U.S. Cl. CPC G06Q 40/03

(57) ABSTRACT

The present disclosure relates to a credit loan, and more particularly, to a credit loan control method and a service computing device based on multiple collaterals of multiple third-party collateral providers and a service computing device therefor. More specifically, the present invention relates to a credit loan control method of a service computing device for providing a predetermined loan amount to a borrower computing device as a loan based on multiple collaterals provided from multiple collateral provider computing devices, the method including dividing corresponding collateral among the multiple collaterals into at least one of a specific ratio or a specific amount or less, including the divided collateral divided by the dividing in the loan, and providing the predetermined loan amount based on the included collateral, in which the multiple collaterals are collected or managed by at least one of a collateral manager computing device or the service computing device.

### CROSS-REFERENCE TO RELATED APPLICATION

This application claims priority to Korean Patent Application No. 10-2022-0094126 filed on Jul. 28, 2022, and all the benefits accruing therefrom under U.S.C. § 119, the contents of which are incorporated by reference in their entirety.

### BACKGROUND

The present disclosure relates to a credit loan, and more particularly, to a credit loan control method and a service computing device based on multiple collaterals of multiple third-party collateral providers and a service computing device therefor.

Loan services can generally be divided into a collateral loan and a credit loan depending on the presence or absence of collateral provided by a borrower.

In the collateral loan, since a loan amount is provided based on the collateral of the borrower, a certain amount proportional to a value of the collateral can be provided as the loan amount. Since a service provider can eliminate a risk of non-repayment of the loan amount through such collateral, the borrower can take out a loan) with very good terms compared to the credit loan. For example, in the collateral loan, since the loan amount is linked to the value of the collateral, if the value of the collateral is high, the borrower can demand a large loan amount as well as a very low interest compared to the credit loan.

In contrast, in the credit loan, in the event of non-repayment of the loan amount, overdue interest, etc., the solution is to rely only on the law, and thus the risk of not getting the principal back cannot be avoided. For this reason, the credit loan has the disadvantage of not being able to avoid a low loan amount, short loan period, high cost (interest), etc. which are very bad terms compared to the collateral loan.

To solve some of these problems, the service provider executes a loan based on information such as credit information or income of the borrower when providing the credit loan, but since it only has the effect of lowering a probability of the non-repayment risk described above, the borrower still has to bear the cost of the risk described above and thus is forced to take out the loan under very unfavorable terms compared to the collateral loan.

In order to solve this problem, the present disclosure provides a control method for providing the credit loan based on multiple collaterals of multiple third-party collateral providers and a service computing device therefor.

### SUMMARY

The present disclosure provides a credit loan control method and a service computing device therefor to solve the problems described above and other problems.

The present disclosure provides a service computing device and a control method for providing a credit loan to a borrower based on multiple collaterals provided by multiple third-party collateral providers so that the borrower can take out the credit loan with good loan terms.

The present disclosure provides a credit loan control method and a service computing device therefor for including only some of multiple collaterals included in a loan in the loan by dividing the multiple collaterals into at least one of a specific ratio or a specific amount or less in order to reduce the risk of non-payment of the loan amount.

The present disclosure provides a credit loan control method and a service computing device therefor for providing different compensation amounts to collateral included in the loan and collateral not included in the loan at a cost borne by borrowers.

The present disclosure provides a credit loan control method and a service computing device therefor for including other non-included collaterals in the loan based on the dividing when the collateral included in the loan is released from the corresponding loan.

The present disclosure provides a credit loan control method and a service computing device therefore for providing collateral for a credit loan by multiple third-party collateral providers provide so as to avoid the risk that the service computing device cannot repay the loan amount.

The technical problems to be achieved in the present disclosure are not limited to the technical problems mentioned above, and other technical problems not mentioned will be clearly understood by those skilled in the art from the following description.

In accordance with an exemplary embodiment of the present invention, there is provided a credit loan control method of a service computing device for providing a predetermined loan amount to a borrower computing device as a loan based on multiple collaterals provided from multiple collateral provider computing devices, the method including dividing corresponding collateral among the multiple collaterals into at least one of a specific ratio or a specific amount or less, including the divided collateral divided by the dividing in the loan, and providing the predetermined loan amount based on the included collateral, in which the multiple collaterals are collected or managed by at least one of a collateral manager computing device or the service computing device.

The credit loan control method of the service computing device may further include imposing an amount including interest on the included collateral to the borrower computing device, and providing a collateral compensation amount to the collateral provider computing device that has provided the included collateral, and the collateral compensation amount may be appropriated using the amount including the interest.

In the credit loan control method of the service computing device, an amount for a risk of non-payment of the predetermined loan amount may be included in the collateral compensation amount so that the risk is compensated.

The credit loan control method of the service computing device may further include calculating a possibility of non-payment of the predetermined loan amount and calculating the amount for the risk based on the calculated possibility.

The credit loan control method of the service computing device may further include providing some of the amount including the interest to a non-included collateral not included in the loan as a standby compensation amount, and an interest rate of the standby compensation amount may be smaller than an interest rate of the collateral compensation amount.

In the credit loan control method of the service computing device, when some or all of the included collateral is released from the loan, the collateral not included in the loan may be included in the loan through the dividing.

In the credit loan control method of the service computing device, in the dividing, the collateral is divided by the multiple collateral providers.

In the credit loan control method of the service computing device, in the including, the divided collateral is included in the loan based on an inclusion criterion.

In accordance with another exemplary embodiment of the present invention, there is provided a service computing device for providing a predetermined loan amount to a borrower computing device as a loan based on multiple collaterals provided from multiple collateral provider computing devices, the device including a communication unit configured to transmit and receive related information to and from the borrower computing device and the multiple collateral provider computing devices, a storage unit configured to store the related information and data, and a control unit configured to perform control in response to the related information and the data, in which the control unit divides corresponding collateral among the multiple collaterals into at least one of a specific ratio or a specific amount, includes the divided collateral in the loan, and provides the predetermined loan amount based on the included collateral, and the multiple collaterals are collected or managed by at least one of a collateral manager computing device and the service computing device.

### BRIEF DESCRIPTION OF THE DRAWINGS

Exemplary embodiments can be understood in more detail from the following description taken in conjunction with the accompanying drawings, in which:

FIG. 1 illustrates a block diagram of a credit loan system in accordance with exemplary embodiment of the present invention;

FIGS. 2 and 3 illustrate flows of control information for providing a loan based on multiple collaterals of multiple third-party collateral providers in accordance with an exemplary embodiment of the present invention;

FIGS. 4 and 5 illustrate block diagrams of a relationship between an amount including interest, a compensation amount, and total collaterals in accordance with the exemplary embodiment; and

FIGS. 6 to 8 illustrate screens of credit loan information, collateral management information, and collateral information in accordance with the exemplary embodiment.

### DETAILED DESCRIPTION OF EMBODIMENTS

Hereinafter, the embodiments disclosed in this specification will be described in detail with reference to the accompanying drawings, but the same or similar components are given the same reference numerals regardless of reference numerals, and redundant descriptions thereof will be omitted. The suffixes “module” and “unit” for components used in the following description are given or used together in consideration of only the ease of describing the specification, and do not have meanings or roles that are distinct from each other by themselves. In addition, in describing the embodiments disclosed in this specification, if it is determined that a detailed description of a related known technology may obscure the gist of the embodiment disclosed in this specification, the detailed description thereof will be omitted. In addition, the accompanying drawings are only for easy understanding of the embodiments disclosed in this specification, the technical idea disclosed in this specification is not limited by the accompanying drawings, and it should be understood as including all alterations, equivalents or substitutes included in the spirit and technical scope of the present invention.

Terms including ordinal numbers such as first, second, etc. may be used to describe various components, but the components are not limited by the terms. These terms are only used for the purpose of distinguishing one component from another.

It should be understood that when a component is referred to as being “connected” or “connected” to another component, it may be directly connected or connected to the other component, but other components may exist in the middle. On the other hand, when a component is referred to as being “directly coupled” or “directly connected” to another component, it should be understood that no other component exists in the middle.

Singular expressions include plural expressions unless the context clearly indicates otherwise.

It should be understood that, in this application, the terms “comprise” or “having” are intended to indicate that a feature, number, step, operation, component, part, or combination thereof described in the specification exists, but the possibility of the presence or addition of one or more other features, numbers, steps, operations, components, parts, or combinations thereof is not precluded.

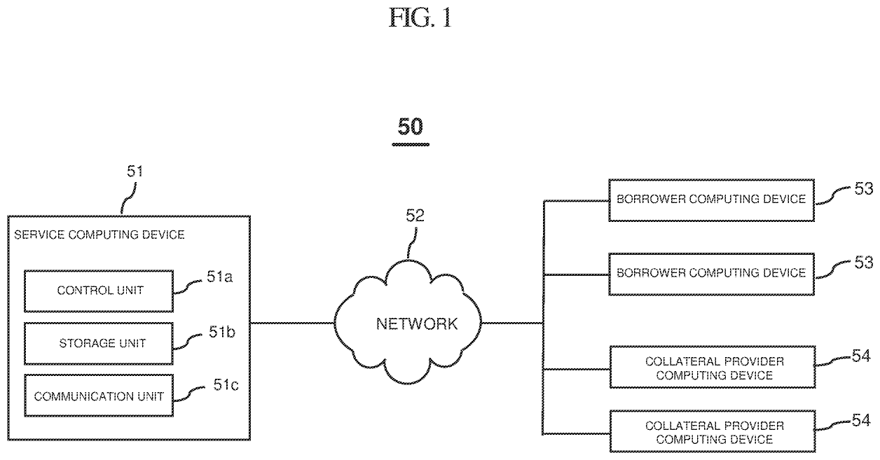

FIG. 1 illustrates a block diagram 50 of a credit loan system according to an embodiment of the present invention.

According to the drawings illustrated, the present invention is configured with a service computing device 51 providing a credit loan, multiple borrower computing devices 53 receiving the credit loan, multiple collateral provider computing devices 54 providing collateral for the credit loan, and a network 52 connecting these devices. Through this, the service computing device may provide a credit loan service of the present invention.

The service computing device 51 may include a control unit 51a, a storage unit 51b, and a communication unit 51c. The control unit 51a is a processor for controlling the overall operation of the service computing device 51 and may be operated by software stored in the storage unit 51b, and may include overall information, related information, and data related to the loan of the present invention. The communication unit 51c is connected to the network 52 and may exchange information related to the credit loan, etc. with the multiple borrower computing devices 53 or the multiple collateral provider computing devices 54.

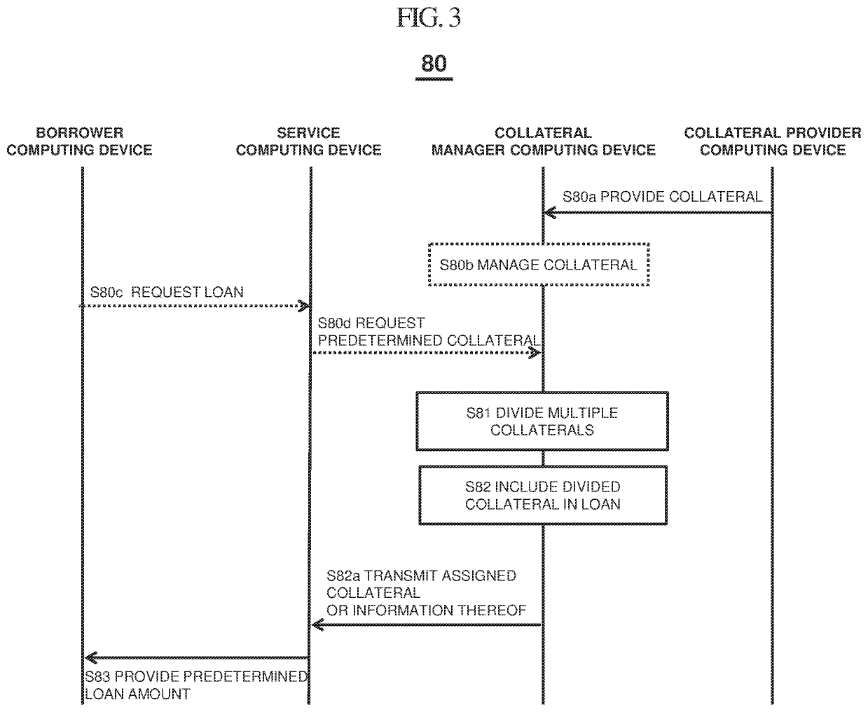

The service computing device 51 is a combination of one or more computing devices, and may be composed of at least one computing device(s) or at least one server(s) having any configuration. When the service computing device is a combination of multiple computing devices, entities controlling the computing devices may be different. That is, control operations of the present invention can be executed not only by the service computing device alone, but also in cooperation with other computing devices. For example, the service computing device is a computing device of a financial institution, and, as illustrated in FIG. 3, this service computing device may execution an operation in cooperation with multiple collateral providers and a collateral manager computing device managing multiple collaterals provided by the multiple collateral providers.

In this way, the control method of the present invention may be executed in cooperation with the service computing device and other computing devices controlled by any other entities. Therefore, there is no restriction on the participation of computing devices of other entities in the control method of the present invention, and such participation can be executed by imitating a conventional method.

The storage unit 51b may be configured to store information and data transmitted from a user computing device. When the service computing device 51 is a combination of multiple computing devices, the computing devices may be configured to be connected to each other by communication and to cooperate and assist with each other. The example of FIG. 1 illustrates a configuration in which a borrower computing device 53 and a collateral provider computing device 54 are connected to each other and transmit related information through the service computing device 51, and the storage unit 51b stores such related information. Since the service computing device 51 can be implemented in various ways, such as a server-client model and peer-to-peer (P2P), there will be no limitation thereto.

In the present invention, the borrower, the collateral provider, and the service provider means their respective computing devices.

Loans can be largely classified into a credit loan and a collateral loan depending on whether or not the borrower provides collateral. In the collateral loan, a borrower provides his or her real estate or assets as collateral and receives a predetermined loan amount corresponding to a value of the collateral.

On the other hand, in the credit loan, it is common to provide a loan by calculating an individual's credit or ability to earn money, such as an annual salary, or ability to pay. However, despite such credit information or income-related information, the problem of non-payment of a loan amount cannot be solved. Because of this problem, the borrower had no choice but to take out loan on very poor terms compared to the collateral loan. For example, a credit borrower had no choice but to accept disadvantages such as very small loan amount, high interest rate, or short loan period. It should be emphasized here that all of these disadvantages of credit loan arise because a service provider (referring to service computing device) should bear the risk of the non-payment of the loan amount.

In order to solve this problem, in the credit loan of the present invention, the borrower receives a collateral from third-party collateral providers and the borrower provides compensation to the third-party collateral providers, thereby eliminating the conventional disadvantages. That is, through these third-party collateral loans, the borrower can take out the loan with larger loan amount and lower interest rate. That is, the credit loan service according to the present invention provides a loan based on multiple collaterals of of the third-party collateral providers.

However, in this case, the risk of the service provider is borne by the collateral provider, and thus it is very important to diversify the risk borne by the collateral provider.

In order to solve this problem, the purpose of the credit loan service of the present invention is to provide multiple collaterals provided by the multiple collateral providers for a specific loan by dividing the multiple collaterals into at least one of a specific ratio or a specific amount. Through this, the risk of non-payment of the loan can be shared among the multiple collateral providers, thereby reducing their respective risks. In addition, the collateral providers can recover their respective risks through the compensation amount.

Therefore, the credit loan of the present invention provides an effect of avoiding the risk of the service computing device not being able to receive repayment of the loan amount by providing the collateral on behalf of the borrower by the collateral provider. The collateral provider may receive a collateral compensation amount in exchange for bearing such risk of the service computing device.

The loan relationship mainly occurs between the service computing device, which is a financial institution such as a bank or a loan company, that pays the loan, and the borrower computing device. In addition, the collateral provider may be a general individual investor or lender who intends to increase personal assets by lending the amount deposited through a financial institution such as a bank to a plurality of others as collateral.

It may be desirable to calculate the loan amount by using the borrower credit information and income-related information such as annual salary. However, without such income information, the loan amount may be determined through a loan criterion such as the value of collateral or the maximum loan amount per individual.

In the present invention, setting registration for the loan amount or collateral can be imitated as it is in the conventional method.

The present invention is characterized in that a credit loan control method of the service computing device 51 for providing a predetermined loan amount to the borrower computing device 53 as a loan based on multiple collaterals provided from the multiple collateral provider computing devices 54, the method including a step of dividing corresponding collateral among the multiple collaterals into at least one of a specific ratio or a specific amount or less, a step of including the divided collateral divided by the dividing in the loan, and a step of providing the predetermined loan amount based on the included collateral, in which the multiple collaterals are collected or managed by at least one of a collateral manager computing device or the service computing device 51.

The present invention is characterized in that the service computing device 51 for providing a predetermined loan amount to the borrower computing device 53 as a loan based on multiple collaterals provided from the multiple collateral provider computing devices 54, the device including the communication unit 51c configured to transmit and receive related information to and from the borrower computing device 53 and the multiple collateral provider computing devices 54, the storage unit 51b configured to store the related information and data, and the control unit 51a configured to perform control in response to the related information and the data, in which the control unit 51a divides corresponding collateral among the multiple collaterals into at least one of a specific ratio or a specific amount, includes the divided collateral in the loan, and provides the predetermined loan amount based on the included collateral, and the multiple collaterals are collected or managed by at least one of a collateral manager computing device and the service computing device 51.

The related information may be information exchanged between the borrower computing device and the collateral provider computing device in relation to the loan of the present invention as well as information generated by the service computing device or the collateral manager computing device itself, or information exchanged between the two devices.

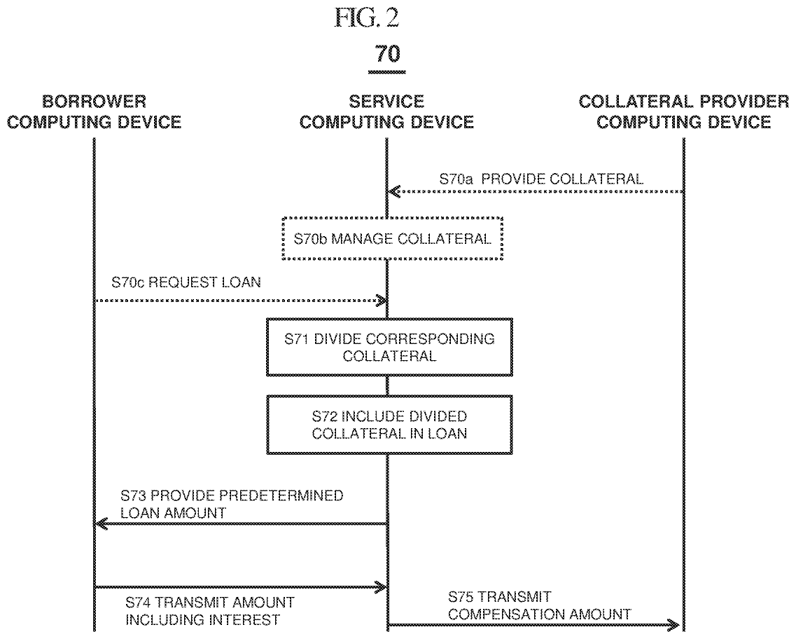

FIGS. 2 and 3 illustrate flows 70 and 80 of control information for providing a credit loan based on multiple collaterals of multiple third-party collateral providers according to an embodiment of the present invention.

FIG. 2 illustrates the flow 70 of control information for the credit loan according to an embodiment of the present invention.

Referring to FIG. 2, in step S70a, the control unit 51a of the service computing device 51 receives multiple collaterals from the multiple collateral provider computing devices 54. The multiple collaterals may be stored so as to be classified by the multiple collateral providers, and later, a dividing step of the present invention described later may be included based on the classification.

Receiving the collateral may include registering as collateral, registering a setting as collateral for a predetermined loan amount of the borrower. Such registration or setting registration can be executed by imitating the conventional method as it is. In this way, the main purpose of the multiple collateral providers providing multiple collaterals as collateral to the borrower may be to obtain commission income, that is, a compensation amount, through the provision of such collateral.

In step S70b, the control unit Ma of the service computing device 51 manages the multiple collaterals received from the multiple collateral provider computing devices. Here, the management may include storing or holding the multiple collaterals, or helping other computing devices to use the multiple collaterals, etc. The present invention is not limited thereto and can be variously modified by imitating various conventional methods.

In S70c step, the control unit 51a of the service computing device 51 receives a request for a loan or credit loan of a predetermined loan amount to from borrower computing device, based on the multiple collaterals from the multiple collateral provider computing devices.

In the present invention, the loan corresponds to a credit loan because the borrower does not provide his or her collateral, and simply refers to a credit loan in which a loan is obtained based on a third-party collateral for a large loan amount and low interest.

Receiving the request for the predetermined loan amount may include accepting by the borrower an amount designated by the service provider as well as an amount designated by the borrower. When the predetermined loan amount is designated and provided by the service provider, the borrower may accept predetermined loan amount as it is or modify it and request a specific amount desired by the borrower again. Such a request can be implemented by imitating a conventional method as it is.

It is obvious that the collateral is provided by the collateral provider, and although it may be desirable that the collateral be arithmetically exactly matched based on a desired loan amount, which is a predetermined loan amount, it is not necessarily exactly matched and should be adjusted enough to perform its role as collateral.

In step S71, the control unit Ma of the service computing device 51 may provide a step of dividing corresponding collateral among the multiple collaterals provided by the multiple collateral providers into at least one of a specific ratio or a specific amount or less.

This step brings the main effect of the present invention. This is because this dividing step distributes the risk of non-payment of the loan amount to the multiple collateral providers by including the collateral of the multiple collateral providers in the loan. That is, the collaterals provided by the multiple collateral providers are included as collateral for any one loan according to the present invention, and the collaterals of the multiple collateral providers are respectively divided into at least one of the specific ratio or the specific amount or less and included in the loan.

Through this, the collateral provider can not only reduce the burden of the risk of non-payment of the borrower, but also increase the assets with his or her surplus funds by being provided with the compensation amount for this risk. Such an effect is obtained by distributing the risk of non-repayment of a predetermined loan amount to multiple collateral providers by the dividing step of the present invention. Therefore, the collateral providers can entrust surplus funds to financial institutions, etc. as deposit or term deposit, and provide these surplus funds as collateral for credit loans of others, and receive the compensation amount therefor. Of course, since the collateral providers bear the risk of non-payment of the loan amount, in return, they will be able to receive a higher compensation amount, that is, interest, than the term deposit or deposit. The term deposit may mean a deferred deposit, and the deposit may mean a demand deposit.

In step S72, the control unit 51a of the service computing device 51 executes a step of including the divided collateral in the loan by the dividing of the present invention.

This divided collateral refers to the collateral divided by the dividing step. The main object of the present invention is to reduce the risk of non-payment of the loan amount as much as collaterals are divided, by dividing the collaterals that are the basis of a credit loan and providing the collaterals by respective ones of the multiple collateral providers. To this end, the present invention may include a step of including the collateral divided by the dividing into a corresponding credit loan.

The dividing step of the present invention is characterized in that the dividing is performed by the multiple collateral providers.

In order to diversify the above-mentioned non-repayment risk for each collateral provider, the control unit 51a can divide the corresponding collateral for each of the multiple collateral providers so that the collateral of each collateral provider is included as collateral corresponding to at least one of the specific ratio or the specific amount or less by each collateral provider, and can include these collaterals as collateral for any one credit loan.

The collateral included in the credit loan by this including step is referred to as included collateral. In order to register the included collateral as collateral for the corresponding loan, a step of registering the included collateral as collateral for the loan may be further included. This registering step may imitate a conventional method as it is.

In step S73, providing, by the control unit 51a of the service computing device 51, the predetermined loan based on the included collateral is included.

Providing the predetermined loan amount to the borrower computing device 53 means providing a predetermined loan amount to an account designated by the borrower or a state in which the borrower computing device can control the predetermined loan amount. The present invention may include various methods for paying the loan amount to the borrower. For example, the loan amount may be transferred to a designated account designated by the borrower. In this way, the service computing device 51 may provide a corresponding loan to the borrower computing device 53 by using multiple corresponding collaterals provided by the multiple third parties as collateral.

In the present invention, it may be preferable that the value of the collateral does not fluctuate over time with respect to the value of the loan or that the value fluctuation is very small. A fixed-value asset is an asset whose value is fixed or has little or no change over time with respect to the loan amount. For example, if a legal currency is paid as a loan amount, the same type of legal currency or stablecoin may be provided as collateral. Therefore, the fixed-value asset does not necessarily have to maintain the same 1:1 value, but may necessarily maintain a similar value of 1:1.

As an example, when a loan is executed in Korean Won (i.e., the loan amount is provided in Korean Won), it is preferable that the borrower receive Korean Won as collateral from a collateral provider, a stablecoin linked to US dollars or Korean Won, etc. In other words, the value of the loan and the second collateral may not change significantly after the loan.

The present invention is characterized in that the collateral is a legal currency, stablecoin, or fixed-value asset.

Stablecoin is a type of crypto currency, such as Bitcoin and Ethereum, and refers to a crypto currency that has a value of 1:1 to a specific legal currency. For example, there may be tether, usdc, and tusd issued by the private sector, and in the future, there may be central bank digital currency (CBDC) which is a state-issued stablecoin issued by various countries. Currently, ‘Digital Yuan’, which is China's state-issued stablecoin, is being issued and circulated.

In the present invention, the predetermined loan amount is an amount of loan amount that a lender or a service provider (hereinafter referred to as a service computing device) pays based on the collateral, and may be legal currency or stablecoin, which is a crypto currency provided to the borrower by the service computing device. The loan amount does not have to be legal currency, and it may any asset that has low price volatility but can be easily converted into cash.

The the present invention further includes a step of imposing, by the control unit 51a, an amount including interest on the included collateral to the borrower computing device, and a step of providing, by the control unit 51a, a collateral compensation amount to the collateral provider computing device that has provided the included collateral are further included, in which the collateral compensation amount is appropriated using the amount including the interest.

In step S74 of the present invention, the control unit 51a may control to receive an amount including interest by the imposing step described above.

In step S75 of the present invention, the control unit 51a may control to transmit a compensation amount appropriated from the amount including interest to the collateral provider computing device. The compensation amount may include a collateral compensation amount and a standby compensation amount.

FIG. 3 illustrates another control information flow 80 for the credit loan according to one embodiment of the present invention.

The embodiment of the present invention in FIG. 2 illustrates an example in which the service computing device simultaneously serves as a service provider and a collateral manager.

In contrast, the embodiment of the present invention in FIG. 3 illustrates the method of controlling the credit loan of the present invention in cooperation with the service computing device for providing a service and the collateral manager computing device for managing collateral although they are separated. The service computing device of FIG. 2 may cooperate with at least one other computing device as illustrated in FIG. 3 to provide the control method of the present invention. This may be implemented by imitating a cooperative method with other computing devices by conventional techniques or methods as it is.

Referring to FIG. 3, steps S80a to S80c and steps S81 to S83 serve as the same role as steps S70a to S70c and steps S71 to S73, respectively, and only the execution subject is separated, and thus detailed descriptions will be omitted.

As described above, among the roles performed by the service computing device of FIG. 2, the roles of service provision and collateral management are separated and divided to be performed the service computing device and the collateral manager computing device as illustrated in FIG. 3. Accordingly, although S80a, S80b, S81, and S82 in FIG. 3 are performed by the collateral manager, the role thereof is the same as that of the service provider in S70a, S70b, S71, and S72 in FIG. 2.

In an embodiment of FIG. 3, the management of the collateral is performed by the collateral manager, and the provision of the loan service is shared by the service provider. For this reason, the example of FIG. 3 may further include steps S80d and S82a than the example of FIG. 2. These steps may simply be that the service provider and the collateral manager are separated and transmit information to each other to provide relevant information to the other party resulting from this separation.

In step S80d, when the service provider requests a predetermined collateral from the collateral manager, a control unit of the collateral manager computing device performs the steps of dividing the collateral and including the divided collateral in the loan through steps S81 and S82, respectively. In step S82a, the collateral provider computing device provides, after completing the step of including the collateral in the loan, the information to the service computing device to assist the service computing device to perform step S83.

The arrows in FIGS. 2 and 3 may indicate control information and a temporal sequence of the control information. However, if the effect of the present invention can be achieved, the steps in this temporal sequence need not be the same as in this example, and this temporal sequence may be changed.

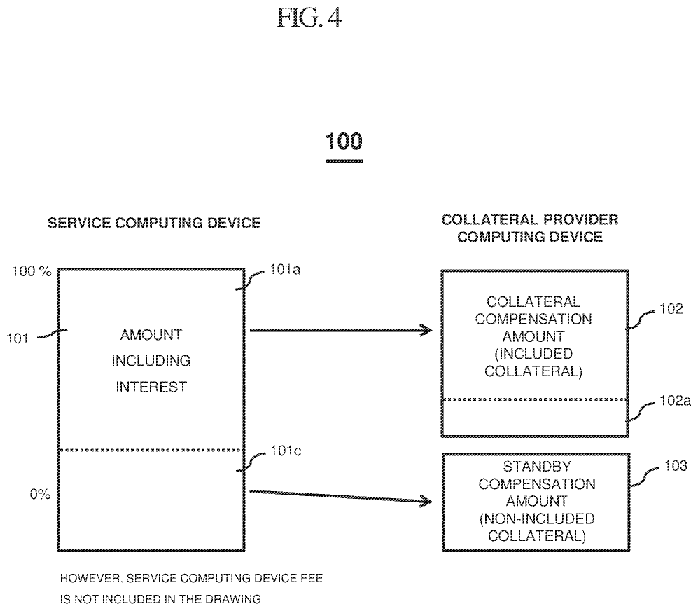

FIGS. 4 to 8 illustrate block diagrams and screens 100 to 140 for describing the loan according to an embodiment of the present invention.

FIG. 4 illustrates a block diagram 100 for distributing an amount including interest on the loan as a compensation amount according to an embodiment of the present invention.

The embodiment of FIG. 4 illustrates the block diagram 100 in which the service computing device 51 provides the collateral provider computing device 54 with an amount including the total interest received from the borrower computing device 53 as a compensation amount. This example is described based on the configuration of FIG. 2.

In the example of FIG. 4, the service computing device may manage an amount 101 including all interest provided by the borrowers and distribute and provide corresponding compensation amounts 102 and 103 to multiple collateral provider computing devices.

The present invention includes the step of providing a part of the amount 101 including the interest as a standby compensation amount 103 to collateral not included in the loan, and an interest rate of the standby compensation amount may be smaller than the interest rate of the collateral compensation amount.

As described above, in the present invention, the compensation amount provided to the collateral provider may be divided into the collateral compensation amount 102 for collateral included in the loan and the standby compensation amount 103 for collateral not included in the loan.

Thus, in the present invention, paying the standby compensation amount for collateral that has not yet been included as collateral for a loan has the purpose and effect of newly including another collateral immediately or preparing a preliminary collateral for a new loan in advance when some of the collateral already provided as collateral is released.

The present invention is characterized in that, when some or all of the included collateral is released from the loan, collateral not included in the loan is included in the loan through the dividing step.

As described above, in the present invention, when some or all of the corresponding collateral is released during the loan, new collateral may be included in the loan in place of the released collateral. This configuration can assist the collateral provider to freely provide collateral for a certain period or without specifying a period. That is, collateral providers can provide demand deposits that can be withdrawn immediately or deferred deposits that are restricted for a specific period of time to a financial institution such as a bank as collateral for credit loans of others. Of course, as described above, it would also be possible for the collateral provider to provide his or her stablecoin as collateral for someone else's credit loan.

The example of FIG. 4 illustrates a method of distributing the amount 101 including all interest transmitted by the borrowers to the collateral provider computing devices. This example shows how to compensate by separating the compensation amount into a collateral compensation amount for the collateral included in the loan and a standby compensation amount for the collateral not included in the loan.

The collateral provider should bear the risk of non-payment of the loan amount. Accordingly, the service computing device or the collateral management computing device may provide corresponding collateral providers with compensation for this, and induce the collateral providers to voluntarily provide their collateral for loans of others. To this end, the present invention may further include an amount 102a for a non-repayment risk in addition to the collateral compensation amount 102 for the risk.

The present invention is characterized in that the amount 102a for the non-repayment risk is included in the collateral compensation amount 102 so that the risk of non-repayment of the predetermined loan amount can be compensated.

To this end, the present invention includes the steps of calculating the possibility of non-repayment of the predetermined loan amount and calculating an amount for the risk based on the calculated possibility.

In this way, in the present invention, the possibility of non-payment of the loan can be calculated. Many conventional techniques such as credit loans and insurance have already been applied to this calculation method. Therefore, the present invention may imitate and apply various conventional methods or techniques. Through this, the control unit 51a of the present invention may perform control to include the amount of the risk in the collateral compensation amount so as to be compensated for the risk of non-payment of the predetermined loan amount.

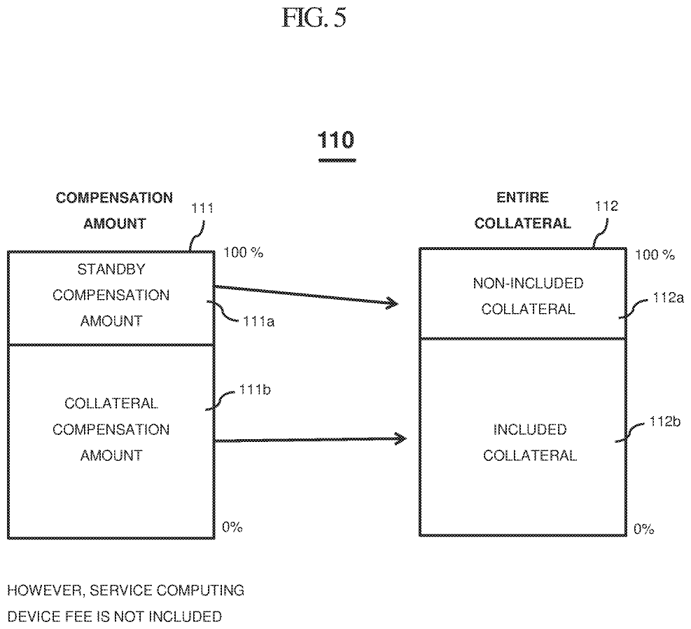

FIG. 5 illustrates a block diagram 110 of compensation amounts for collateral included in the loan and collateral not included in the loan according to an embodiment of the present invention.

The example of FIG. 4 describes the distribution of the compensation amount from the perspective of the service provider and the collateral provider. However, the example of FIG. 5 is the diagram 110 for describing the relationship between the compensation amount and the entire collateral.

Total collateral 112 refers to all collaterals provided by all collateral providers as collateral for a loan of another person, which can be divided into collateral 112a included in the loan and collateral 112b not included in the loan. Also, as described above in FIG. 4, the compensation amount 111 may be classified into a collateral compensation amount 111b and a standby compensation amount 111a as illustrated in FIG. 5.

As in the example of FIG. 5, among the compensation amount 111, the standby compensation amount 111a and the collateral compensation amount 111b may be provided to the non-included collateral 112a and the included collateral 112b as compensation for providing collateral, respectively. However, in FIGS. 4 and 5, the compensation amount will not include the fee taken by the service computing device or the collateral manager computing device.

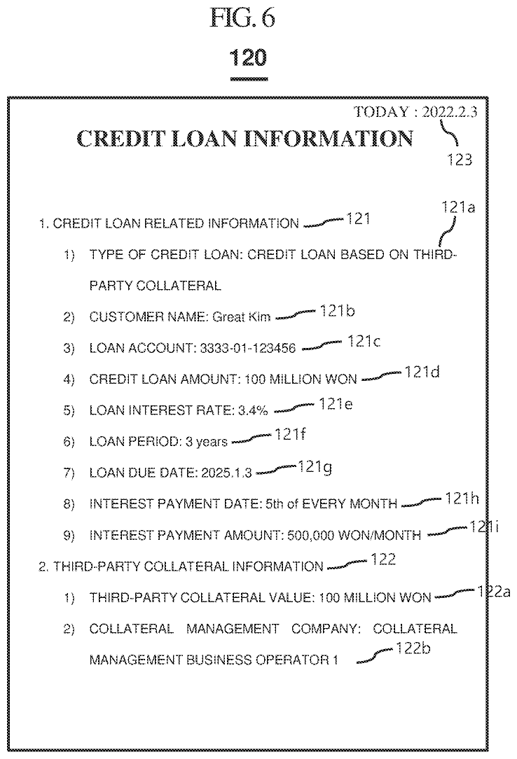

FIG. 6 illustrates a screen 120 for displaying credit loan information according to an embodiment of the present invention.

The example of FIG. 6 is the screen 120 of the computing device displaying credit loan information of the borrower, Great Kim 121b. For reference, the current date of this screen is 2022.2.3 123.

In this example, credit loan information can be largely classified into credit loan related information 121 and third-party collateral information 122. First, the credit loan related information 121 includes ‘credit loan based on a third-party collateral as a type of credit loan’ 121a, ‘customer Name: Great Kim’ 121b, ‘loan account: 3333-01-123456’ 121c, ‘credit loan amount: 100 million won’ 121d, ‘loan interest rate: 3.4%’ 121e, ‘loan period: 3 years’ 121f, ‘loan due date: 2025.1.3’ 121g, ‘interest payment date: 5th of every month’ 121h, and ‘interest payment amount: 500,000 won/month’ 121i.

Compared to conventional credit loans, the effect of the present invention that can be confirmed from this information 121 is that 1) the credit loan amount is very large at 100 million won, 2) the loan interest rate is very low at 3.4%, and 3) the loan period is very long at 3 years. All of these effects occur because credit loans are provided based on collateral of a third-party collateral provider. In other words, these are the effects that occur because the service provider does not have to bear any risk of non-payment on the loan amount. On the other side, it provides the advantage that collateral providers can increase their own assets by providing collateral for loans of others.

Secondly, the third-party collateral information 122 includes ‘third-party collateral value: 100 million won’ 122a and ‘collateral management company: collateral management business operator 1’ 122b. Therefore, it can be confirmed that the collateral provided by the third-party for this loan is ‘100 million won’ 121d and 122a, which is the same as the loan amount. This is an example in which multiple collateral providers provide approximately 100% collateral 122a for the loan amount 121d. In addition, this example illustrates that the service computing device and the collateral manager computing device are separated as illustrated in FIG. 3, and thus the collateral manager is ‘collateral management operator 1’ 122b.

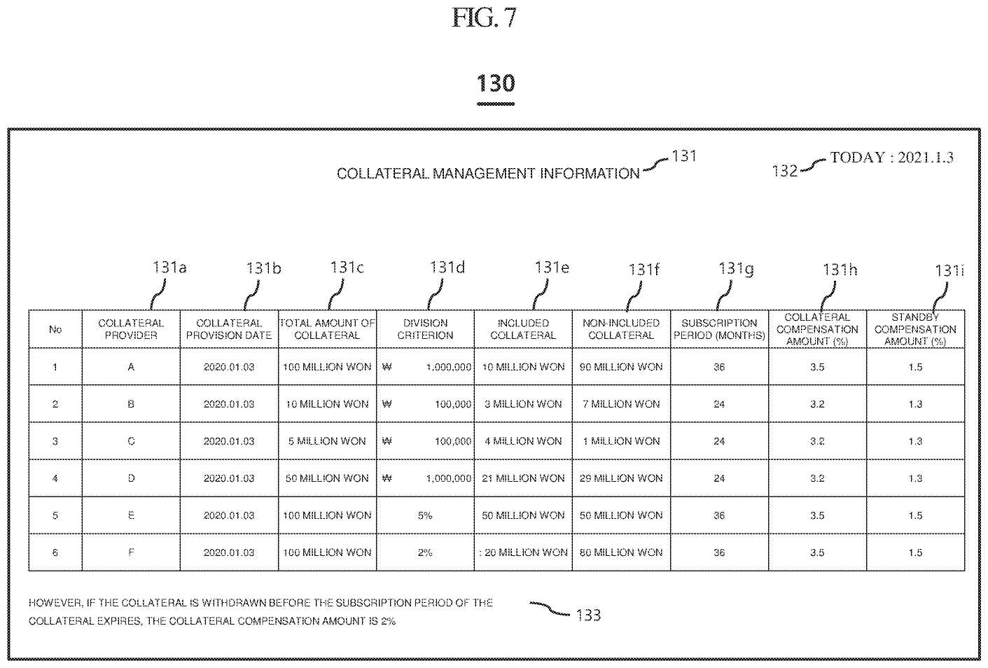

FIG. 7 illustrates a screen 130 displaying collateral management information according to an embodiment of the present invention.

This example illustrates the screen 130 of the collateral management information 131 managed by the service computing device or the collateral manager computing device.

This information 131 includes detailed information 131b to 131i about collateral providers and collaterals provided by them. Specifically, the collateral management information 131 includes ‘collateral provider name’ 131a, ‘collateral provision date’ 131b, ‘total amount of collateral’ 131c, ‘division criterion’ 131d, ‘included collateral’ 131e, ‘non-included collateral’ 131f, ‘subscription period (months)’ 131g, ‘collateral compensation amount (%)’ 131h, and ‘standby compensation amount (%)’ 131i.

This example includes the ‘division criterion’ 131d. This may be designated by each borrower or designated by the service computing device. In this division criterion, at least one of a specific ratio or a specific amount of the total amount of collateral 131c may be designated. This example illustrates the case of including both percentage and amount. This shows that each of the collateral providers 131a specifies the maximum amount of collateral that can be provided for each loan according to their division criteria. As described above, this is provided to reduce the risk of non-repayment of the loan amount by the collateral provider in the loan of the present invention.

In this example, the ‘subscription period’ 131g may mean the total period until the maturity of the deferred deposit. In this example, the compensation amount is divided into a ‘collateral compensation amount’ 131h and a ‘standby compensation amount’ 131i, and includes an interest rate (%) for each of them. It shows, in the present invention, that the interest rate of the collateral compensation amount is higher than the interest rate of the standby compensation money. In this example, the collateral compensation amount 131h and the standby compensation amount 131i are different for each collateral provider 131a.

The screen 130 includes information on the collateral compensation amount when the collateral is withdrawn before maturity. That is, ‘However, if the collateral is withdrawn before the subscription period of the collateral expires, the collateral compensation amount is 2%’ 133 is included at the bottom of the screen 130.

The present invention is characterized in that the collateral compensation amount is provided as at least one of a differential rate or an equal rate according to the compensation conditions of each collateral provider who provided the included collateral.

For example, the compensation conditions may be based on conditions such as a transfer limit period of the collateral, that is, the subscription period 131g, etc. Such compensation conditions may be implemented by imitating a conventional loan method, etc. as it is.

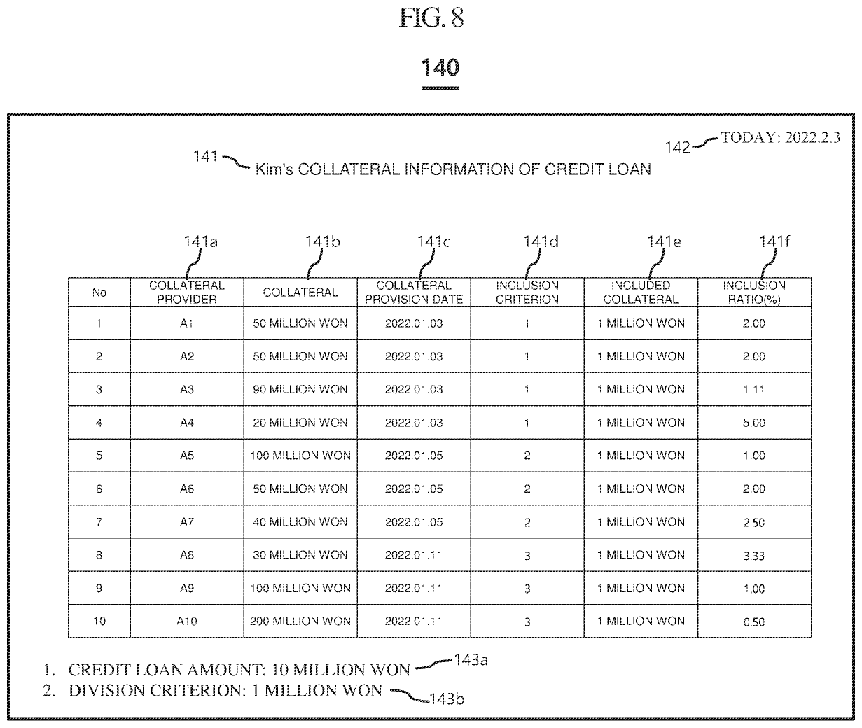

FIG. 8 illustrates a screen 140 for displaying collateral information included in the loan of the borrower according to an embodiment of the present invention. The current date on this screen is 2022.2.3.

The present invention is characterized in that, in the including step, the divided collateral is included in the loan based on an inclusion criterion.

This example is a screen 140 illustrating collateral information 141 of credit loan of Kim who is the borrower. This example shows that the ‘credit loan amount (i.e., loan amount)’ is ‘10 million won’ 143a, and the ‘division criterion’ is ‘1 million won’ 143b. Accordingly, this table 141 shows collateral information of all collateral providers included in a loan of a specific borrower. In this example, the loan amount 143a and the collateral 141e included in the loan corresponds to the case of the same 10 million won.

In this example, items 141a to 141f of the table include collateral providers 141a, collateral 141b, date and time of provision 141c, inclusion criterion 141d, included collateral 141e, and inclusion ratio 141f.

Here, the ‘inclusion criterion’ 141d may mean a criterion for including the divided collateral in a corresponding loan based on the inclusion criterion in the including step of the present invention. In this example, the inclusion criteria are indicated by 1, 2 and 3. This criterion may be to provide a criterion for the inclusion of collateral in the loan. For example, this criterion may be such that, when a new credit loan occurs, first, the collaterals of the collateral providers with the best inclusion criterion 1 are included as collateral according to the division criterion 131d, and then the collateral with the inclusion criterion 2 is included as collateral.

In the above, although the service computing device for providing a credit loan based on collateral of the collateral provider and the control method therefor according to the present invention have been described, this is described as at least one embodiment. The technical spirit of the present invention and its configuration and operation are not limited by the service computing device and the control method therefor described above, and the scope of the technical idea of the present invention is not restricted/limited by the drawings or the description referring to the drawings. In addition, the concepts and embodiments of the present invention presented in the present invention can be used by those skilled in the art as a basis for modifying or designing them into other structures in order to achieve the same purpose of the present invention. Equivalent structures modified or changed by those skilled in the art to which the present invention belongs are bound by the technical scope of the present invention described in the claims, and can be variously changed, replaced, and altered without departing from the spirit or scope of the invention described in the claims.

Effects of the computing device and the control method for providing a credit loan based on multiple collaterals of the multiple third-party collateral providers according to the present invention will be described as follows.

The present invention has an effect of providing a credit loan to a borrower based on multiple collaterals provided by multiple third-party collateral providers so that the borrower can take out the credit loan with good loan terms.

The present invention has an effect of including only some of multiple collaterals included in a loan in the loan by dividing the multiple collaterals into at least one of a specific ratio or a specific amount or less in order to reduce the risk of non-payment of the loan amount.

The present invention has the effect of providing different compensation amounts to collateral included in the loan and collateral not included in the loan at the cost borne by borrowers.

The present invention has the effect of including other non-included collaterals in the loan based on the dividing when the collateral included in the loan is released from the corresponding loan.

The present invention has the effect of providing collateral for the credit loan by multiple third-party collateral providers so as to avoid the risk that the service computing device cannot repay the loan amount.

A further scope of the applicability of the present invention will become apparent from the detailed description that follows. However, various changes and modifications within the spirit and scope of the present invention can be clearly understood by those skilled in the art, and thus it should be understood that the detailed description and specific examples such as preferred embodiments of the present invention are given as examples only.

Although the credit loan control method and the service computing device therefor have been described with reference to the specific embodiments, they are not limited thereto. Therefore, it will be readily understood by those skilled in the art that various modifications and changes can be made thereto without departing from the spirit and scope of the present invention defined by the appended claims.

What is claimed is:

1. A credit loan control method of a service computing device for providing a predetermined loan amount to a borrower computing device as a loan based on multiple collaterals provided from multiple collateral provider computing devices, the method comprising:
dividing corresponding collateral among the multiple collaterals into at least one of a specific ratio or a specific amount or less;
including the divided collateral divided by the dividing in the loan;
providing the predetermined loan amount based on the included collateral;
calculating a possibility of non-payment of the loan provided;
calculating an amount for a risk of the included collateral based on the calculated possibility; and
calculating a collateral compensation amount for the multiple collaterals provided, wherein
the multiple collaterals provided are divided into collateral included in the loan and collateral not included in the loan,
in the calculating, the collateral compensation amount is calculated in consideration of the amount for the risk is taken into consideration when calculating the collateral compensation amount for the collateral included in the loan, and
the multiple collaterals are collected or managed by at least one of a collateral manager computing device or the service computing device.

2. The method of claim 1, further comprising:
imposing an amount including interest on the included collateral to the borrower computing device; and
providing the calculated collateral compensation amount to the collateral provider computing device, wherein
the collateral compensation amount is appropriated using the amount including the interest.

3. The method of claim 2, further comprising:
providing some of the amount including the interest to a non-included collateral not included in the loan as a standby compensation amount, wherein
an interest rate of the standby compensation amount is smaller than an interest rate of the collateral compensation amount.

4. The method of claim 1, wherein
when some or all of the included collateral is released from the loan, the collateral not included in the loan may be included in the loan through the dividing.

5. The method of claim 1, wherein
in the dividing, the collateral is divided for each of the multiple collateral providers.

6. The method of claim 1, wherein
in the including, the divided collateral is included in the loan based on an inclusion criterion.

7. A service computing device for providing a predetermined loan amount to a borrower computing device as a loan based on multiple collaterals provided from multiple collateral provider computing devices, the device comprising:
a communication unit configured to transmit and receive related information to and from the borrower computing device and the multiple collateral provider computing devices;
a storage unit configured to store the related information and data; and
a control unit configured to perform control in response to the related information and the data, wherein
the control unit
divides corresponding collateral among the multiple collaterals into at least one of a specific ratio or a specific amount,
includes the divided collateral in the loan, and
provides the predetermined loan amount based on the included collateral,
calculates a possibility of non-payment of the loan provided,
calculates an amount for a risk of the included collateral based on the calculated possibility, and
calculates a collateral compensation amount for the multiple collaterals provided,
the multiple collaterals provided are divided into collateral included in the loan and collateral not included in the loan,
the control unit calculates the collateral compensation amount in consideration of the amount for the risk when calculating the collateral compensation amount for the collateral included in the loan, and
the multiple collaterals are collected or managed by at least one of a collateral manager computing device or the service computing device.

8. The method of claim 7, wherein
the control unit
imposes an amount including interest on the included collateral to the borrower computing device, and
provides the calculated compensation amount to the collateral provider computing device, and
the collateral compensation amount is appropriated using the amount including the interest.
